(19) United States
(12) Patent Application Publication
(10) Pub. No.: US 2011/0158469 A1
(43) Pub. Date: Jun. 30, 2011

(54) METHODS AND APPARATUS FOR MANAGEMENT OF FIELD OPERATIONS, PROJECTS AND/OR COLLECTED SAMPLES

(76) Inventor: JUSTIN P. MASTYKARZ, PISCATAWAY, NJ (US)

(21) Appl. No.: 12/980,876

(22) Filed: Dec. 29, 2010

Related U.S. Application Data
(60) Provisional application No. 61/290,806, filed on Dec. 29, 2009.

(51) Int. Cl. G06K 9/00

(52) U.S. Cl. 382/100

(57) ABSTRACT

Methods and apparatus for collecting samples and watermarking pictures relating to the samples are described. Watermarks may include site specific information, e.g., room, floor number, etc. in addition to GPS location. Project number and information relating to the test may also be included in the watermark. A watermarked photo of the site location from which a sample is collected is generated. A watermarked photo of the container including the sample is also generated. Watermarked photos of the test site and sample containers may be stored in association with the samples and other chain of custody information. Watermarked photos are electronically communicated to a testing facility and maintained in a database with test results generated from the testing of the sample(s). Pictures and test results are electronically accessible. A list of individuals handling the samples may also be included the database as part of a documented physical chain of sample custody.

### RELATED APPLICATIONS

The present application claims the benefit of U.S. Provisional Patent Application Ser. No. 61/290,806 filed Dec. 29, 2009 which is hereby expressly incorporated by reference in its entirety.

### FIELD

The present application is directed to methods and apparatus for managing field operations, projects and collection and identification of samples.

### BACKGROUND

Testing of sites, e.g., for chemical contamination, is used in a wide range of applications including environmental consulting, criminal justice, civil litigation, etc.

Often testing results come into question with inquiries being made as to whether a collected sample actually corresponds to a particular site or location and/or whether the test results are reliable.

In view of the above, it should be appreciated that there is a need for improving sample collection and documentation techniques relating to establishing a chain of custody and that a particular sample corresponds to a particular site. There is also a need for methods and apparatus for providing efficient access to test reports and results corresponding to a sample which is collected and tested.

In view of the above discussion it should be appreciated that there is room for improvement with regard to sample collection, documentation relating to collected samples and/or access to test results relating to collected samples.

### SUMMARY

Methods and apparatus for collecting and identifying samples are described. Methods and apparatus for associating sample information and test results which can be accessed electronically are also described.

The methods and apparatus of the present invention are particular well suited for environmental testing and reporting applications. In accordance with one exemplary embodiment, information corresponding to a project, e.g., a site testing project, are entered in to a database which is part of a record keeping and report generation system. The record keeping and report generation system may be located at a testing facility were samples, e.g., soil, water or other types of samples, are taken for processing after collection from the site to be tested.

The methods and apparatus of the present invention can be used to simply recording keeping, maintain a chain of custody (CoC) and facilitate report generation and access to reports.

In accordance with various embodiments, after information relating to a project is entered into the Record Keeping and Report Generation (RKRG) system, an engineer or another individual is sent to a site to be tested for collection of samples. The information entered into the RKRG system may include information including a project identifier, e.g., project number, information about the sites to be tested, e.g., geographic location such as site address, the type and number of samples to be taken from each site or particular portion of a site, information identify the party ordering the report, information identifying the individuals performing sample collection, information identifying the individuals, employees and/or customer's to be allowed remote access to the sample and report information as well as other information such as the encryption method and/or passwords to be used by one or more individuals or customers when accessing the RKRG or information/reports which are generated by the system.

An individual sent to collect samples from a site, goes to the site. The individual takes a picture of the portion of the site from which a sample is to be collected using a portable communications device, e.g., cellular telephone or tablet including a camera. The electronic communications devices watermarks the picture of the site from which the sample is collected adding various information to a digital image which forms the picture captured by the camera. The watermark may involve placement of text over a portion of the captured picture and/or embedding information into the image by altering pixel values. In some embodiments, at least a portion of the watermark is visible and can be readily detected by the naked eye when the watermarked picture is viewed. Visible information normally includes information indicating the particular site and location at the site from which the corresponding sample was taken, the time the picture of the site was taken, the project number to which the picture and sample correspond and the name of the individual taking the sample. A number used to identify the sample to which the picture of the site corresponds may also be included in the watermark. GPS coordinates, date, time and information identifying the device used to capture the image may also be included in the watermark but some or all of this additional information may not be visible to the detected eye by may be read from the electronic file used to store the picture or embedded directly into the picture by altering pixel values in a predetermined manner which can later be detected and read by a machine. Various techniques of watermarking images are known in the art and any of one or more image watermarking techniques may be used in accordance with the invention. Accordingly, while exemplary techniques have been discussed, the methods and apparatus described herein are not limited to a particular method.

After taking the picture of the portion of a site from which a sample is to be collected, the sample is collected and placed in a jar or other container. The container is labelled with a sample number or other identifying indicia which may be included in the watermark which was added to picture of the portion of the site from which the sample was collected.

A picture of the container including the collected sample is taken using the mobile communications device. The collected sample may or may not be visible in the container. The picture of the container including the collected sample is watermarked in the same or similar manner as the picture of the portion of the site from which the sample was collected.

The watermarked picture of the site are stored in the portable device but also wirelessly communicated to the RKRG system, e.g., via a cellular or WIFI network. Thus, the RKRG system is made aware of what samples were collected and can readily track them. The pictures provide a detailed record of the site and sample containers which can be used to establish a chain of custody and detect sample tampering, e.g., by switching of sample containers after collection.

Multiple samples may be collected from one or more sites in the above described manner with pictures, e.g., digital watermarked photos, of the test sites and sample containers being sent back to the RKRG system.

The collected samples are returned to the testing center for testing. At the test center, the watermarked test site picture and/or watermarked picture of the sample container including the sample sent from the test site are printed and stored in association with the collected sample. The printed watermarked images are associated with the collected samples, in some embodiments, by securing the printed watermarked images to a container used to store the samples. The container used to store the samples may hold one or more of the containers used at the test site to hold the collected sample(s). In some cases associating the watermarked image(s) which container used to store the corresponding sample(s) involves gluing or securing the printed watermarked pictures to the container in which the sample(s) are stored. In other embodiments, the printed watermarked picture(s) are placed in a pouch or envelope secured to the container in which the sample(s) are stored. The container in which the sample or sample(s) are stored may hold multiple samples collected from a site, e.g., with each individual sample being stored in a separate vial or container within the larger container used at the test facility for sample storage.

Information about the person who collected the sample and one or more individuals who were responsible for the testing of the collected sample are entered into the RKRG system. Thus, for each sample which is collected and tested, the RKRG maintains information providing a complete chain of custody. Samples are tested and the test results are also stored in the RKRG system.

Reports corresponding the tested samples and the testing of a site may be accessed remotely via one or more wireless or wired communications devices which can connect to the RKRG system, e.g., via the Internet. For security reasons, communications, including the electronic communication of watermarked pictures, test results, etc. may and in some embodiments are, encrypted with the RKRG system decrypting encrypted information and images it receives and user devices decrypting encrypted information received from the RKRG system.

The methods and apparatus of the present invention are particularly well suited for environmental testing applications and/or other applications where samples are collected, tested, and provided in a secure and/or confidential manner. In addition, the methods and apparatus of the present invention facilitate maintaining a detailed record of the sample collection and testing processes as well as a chain of sample custody. Thus, not only is reliability and the trustworthiness of the test results increased as compared to some other systems, but the results are particularly well suited for court use where the chain of custody may need to be established and it may be important that the tested sample is the sample which was actually collected at a particular site.

While well suited for environmental applications, the methods and apparatus of the present invention can be applied to criminal cases where samples need to be collected and tested as well as a wide variety of other applications.

Numerous additional features, benefits and embodiments are described in the detailed description.

### BRIEF DESCRIPTION

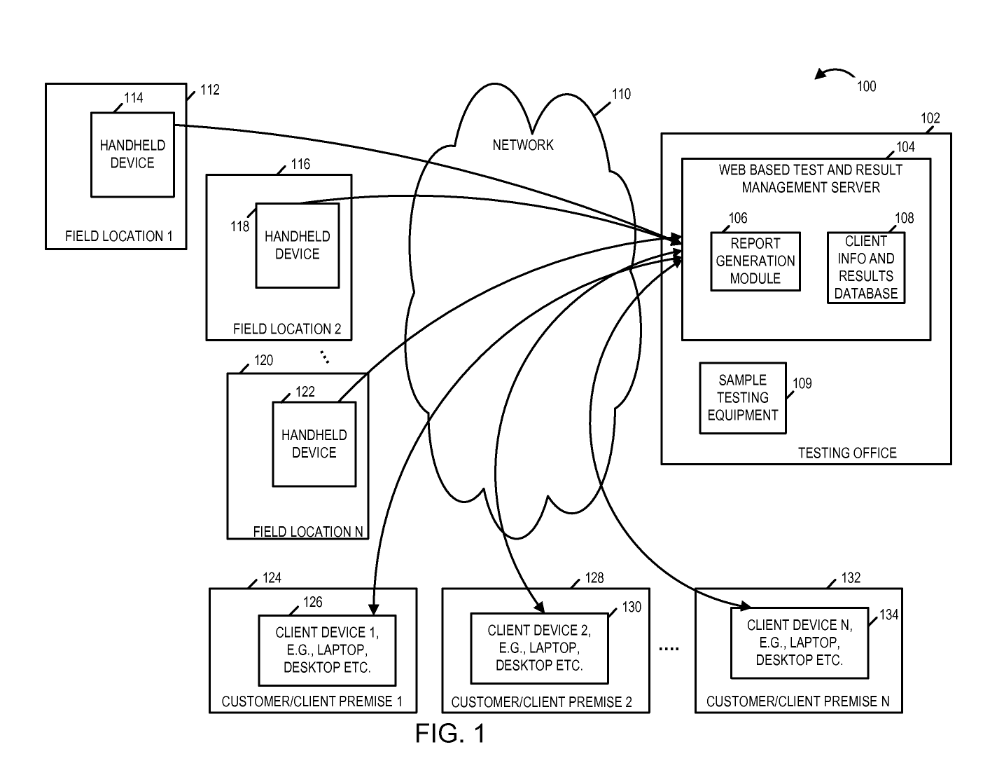

FIG. 1 illustrates an exemplary system implemented in accordance with one aspect of the invention.

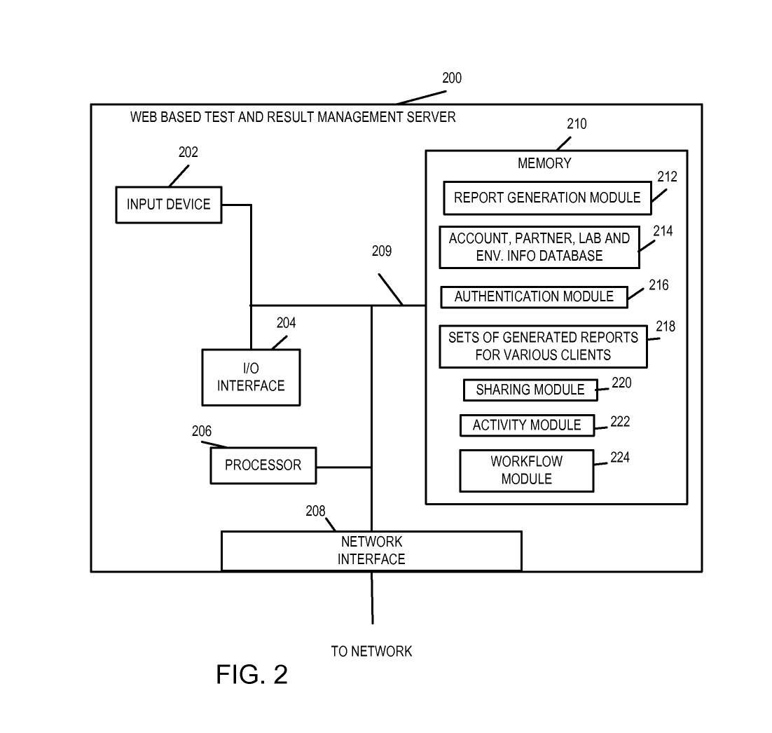

FIG. 2 illustrates an exemplary web based management server implemented in accordance with one exemplary embodiment.

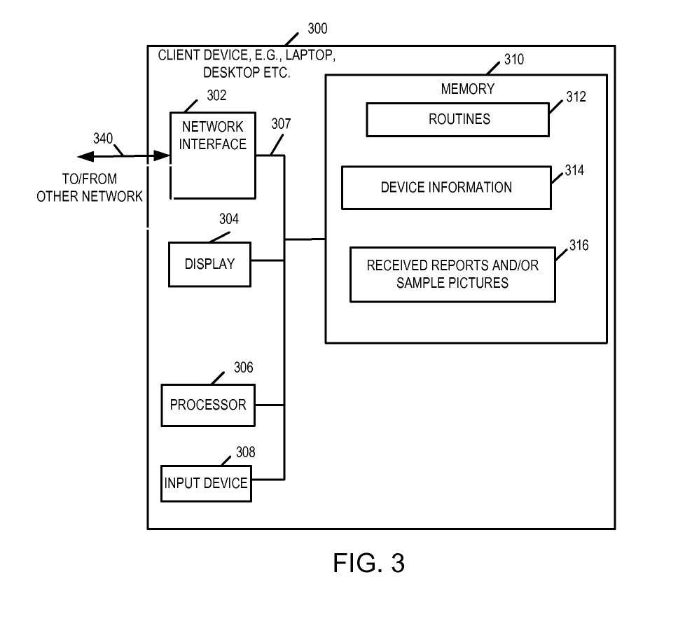

FIG. 3 illustrates an exemplary client device in accordance with one embodiment of the invention.

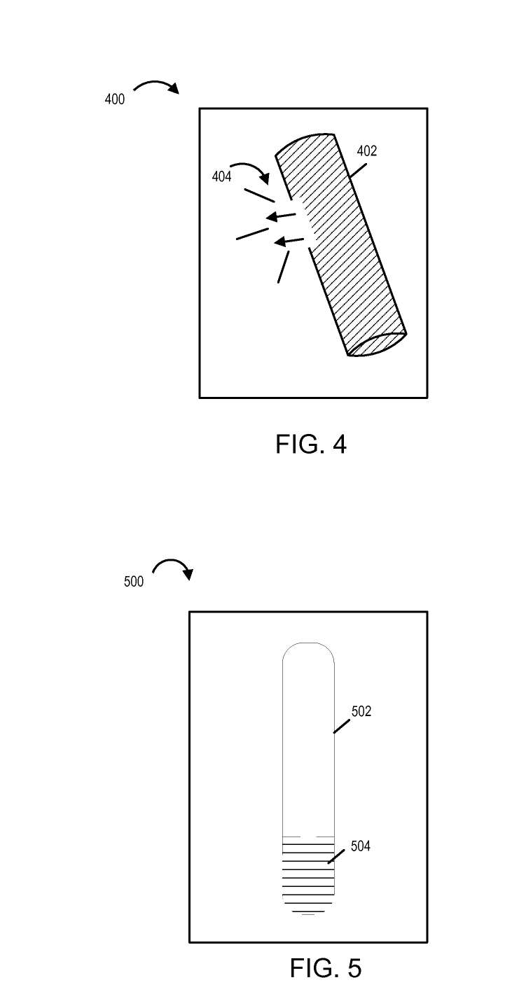

FIG. 4 illustrates a picture of a portion of an exemplary site from which an exemplary sample is collected in accordance with one embodiment of the invention.

FIG. 5 illustrates a picture of a container including an exemplary sample collected from a site, in accordance with one embodiment of the invention.

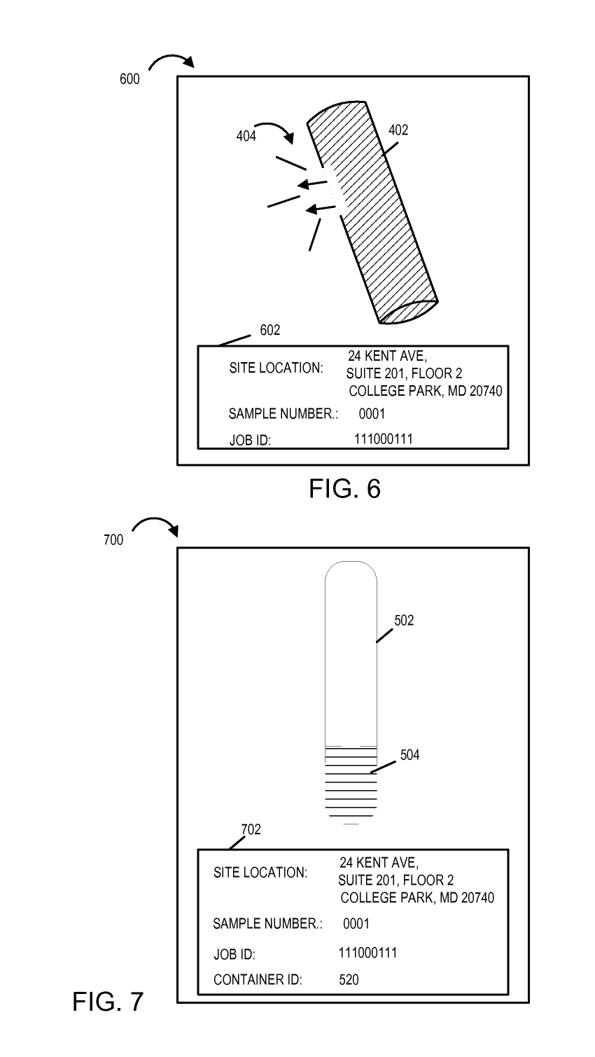

FIG. 6 illustrates a watermarked version of the picture shown in FIG. 5, in accordance with one embodiment of the invention.

FIG. 7 illustrates a watermarked version of the picture of the container including a sample shown in FIG. 6, in accordance with one embodiment of the invention.

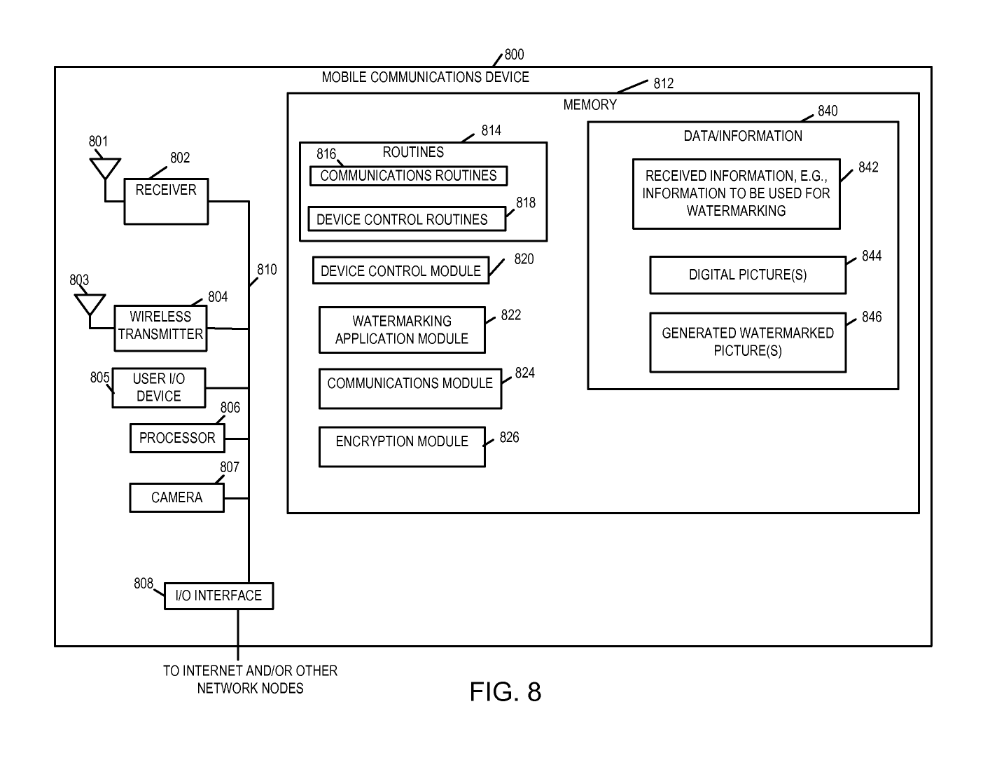

FIG. 8 illustrates an exemplary handheld device, e.g., a mobile communications device, in accordance with one embodiment of the invention.

### DETAILED DESCRIPTION

FIG. 1 illustrates a system 100 implemented in accordance with one aspect of the invention. Clients can create and/or define a plurality of geographical field locations e.g., sites, where one or more samples on which tests have to be performed are located. In some embodiments the tests are conducted at the field locations 114, 116, and 120. The field locations 112, 116 and 120 are also referred to as sites. System 100 further includes a testing management office 102 including a web based management server 104. Various elements of the system communicate, e.g., exchange information, with each other over the network 110 which could be, e.g., Internet or another communications network. In accordance with one aspect of the invention handheld devices 114, 118 and 122 shown in each of the field locations 112, 116 and 120, respectively are capable of taking sample pictures and collecting test data in real time from the field locations/sites, watermarking the sample pictures with relevant information and communicating the watermarked pictures and sometimes other relevant test data/information to the testing office 102 including the web based test management server 104. In some embodiments the handheld devices can communicate the information relevant for sample testing directly to a computer, e.g., wirelessly and/or using a physical connection. In some embodiments the handheld devices 114, 118 and 122 are mobile communications devices such as a tablet device or a cell phone.

The testing office 102 includes the web based test and result management server 104 and one or more sample testing apparatus 109. The sample testing apparatus 109 include testing equipments for testing various collected samples. The web based test and result management server 104 includes report generation module 106 for generating and/or compiling reports from the project, field location, document information as well as test data and lab analysis. In some embodiments the test data, lab analysis, sample pictures etc., are received from the handheld devices 114, 118, 122 in the system. In some embodiments some of the information is received from the handheld devices while the actual tests are conducted on a sample at the testing office 102 itself using the sample testing apparatus 109. Server 104 further includes a client information and results database 108. The client information and results database 108 stores information associated with various clients, field locations/sites, projects/jobs corresponding to various clients, and the environmental information and test data/results corresponding to tests which may have been either conducted at the testing office 102 or communicated from one or more handheld devices. The report generation module 106 uses the above data sources to create job related reports. The testing office 102 is also referred to as sample processing facility. The database 108 includes information which is used for watermarking samples at field locations. In some embodiments such information which is used for watermarking samples includes at least one of job and/or project identification information, or site identification information. In various embodiments this information is communicated from the management server 104 to one or more handheld devices 114, 118, 122.

Customer premises 124, 128 and 130 include client devices 126, 130 and 134 respectively. The client devices 126, 130 and 134 may be, e.g., a laptop, a desktop workstation etc., and can communicate with the management server 104 over the network 110. In accordance with one feature, clients can use the client devices to access, store information and the test result reports prepared in the management server 104, track progress of their projects and/or tests that are being conducted on collected samples at one or more field locations or at the testing office, share project/test data with a team member or a group of members. In various embodiments the handheld devices 114, 118, 122 and the client devices 126, 130, 134 include a web browser and can access the internet. In various embodiments data can be managed and updated via the World Wide Web through either a computer or handheld device equipped with internet access.

FIG. 2 illustrates an exemplary web based management server 200 implemented in accordance with one exemplary embodiment. The web based management server 200 may be used as the server 104 of the system shown in FIG. 1. Server 200 includes an input device 202, an input/output interface 204, a processor 206, a network interface 208 and memory 210 which are coupled together via bus 209. In some embodiments a display device, such as a monitor, may also be a part of the server 200.

Various elements of the server 200 can exchange data and information over the bus 209. The Input device may be, e.g., a keypad, via which an operator may enter data and/or commands in the server 200. Via the I/O interface 204, the management server 200 can exchange signals and/or information with other devices. The I/O interface supports the receipt and/or transmission of data, information and/or content to/from different servers, devices such as handheld devices 114, 118, 122 and other systems. The processor 206, e.g., a CPU, controls the management server 200 to operate in accordance with the invention. To control the management server 200, the processor 206 uses information and/or routines including instructions stored in memory 210. Management server 200 can connect to different networks via the network interface 208.

Memory 210 includes a report generation module 212, account, partner, lab and environmental information database 214, an authentication module 216, sets of generated reports for various clients 218. Although not shown separately the memory 210 also includes routines for controlling the operation of management server 200 in accordance with the invention. The report generation module 212 and database 214 perform the same or similar function as discussed with regard to elements 106 and 108 of the management server 104 in FIG. 1. The authentication module 216 is used by the management server 200 to authenticate the clients who wish to access the test reports and/or other information related to their projects. Sets of generated reports 218 include one or more reports generated by the report generation module 212 which can be accessed by the clients to which these reports correspond.

FIG. 3 illustrates an exemplary client device 300 in accordance with one embodiment of the invention. The client device 300 may be used as any of the client devices 126, 130 and 134 shown in FIG. 1. Client device 300 can be a laptop, desktop etc. The client device 300 includes a network interface 302, a display device 304, e.g., monitor, a processor 306, an input device 308, and memory 310 which are coupled together via bus 307.

Various elements of the client device 300 can exchange data and information over the bus 307. The Input device may be, e.g., a keypad, via which a user/operator may enter data and/or commands in the client device 300. The processor 306, e.g., a CPU, executes routines 312 stored in the memory 310 and, under direction of the routines 312, controls the device 300 to operate in accordance with the invention. The network interface 302 couples the client device 300 to an external network, e.g., the Internet, thereby allowing the client device 300 to receive and send data/information over a network.

Memory 310 includes routines 312, device information 314, and received reports and/or sample pictures 316. Routines 312 are used for controlling the operation of the client device 300. The device information may client device ID, e.g., workstation ID, Media Access Control (MAC) address of the device, etc. and or other information stored in the client device memory 310. In some embodiments the client device 300 uses the device information 314 for getting authentication from the management server 200 to gain access to reports/test data etc. Received reports 316 include one or more reports which have been downloaded and/or received from the management server 200. In some embodiments the received reports include pictures of the sample collected from a site. The sample pictures may be watermarked, e.g., labelled with information relevant to the site, site location, project/job and/or information relevant to a collected sample.

FIG. 4 illustrates a picture 400 of a portion of an exemplary site from which an exemplary sample is collected in accordance with one embodiment of the invention. The picture 400 may, and in some embodiments is taken from a digital camera which may be included in a mobile communications device. The picture 400 includes a portion of the site from which the sample is collected. The exemplary picture 400 shows a broken pipe 402 and the portion 404 of the pipe which is leaking or damaged. In one embodiment a liquid spewing out of the broken pipe 402 from the leaking portion 404 is collected as the sample on which one or more tests are to be performed, e.g., to determine or verify the concentration and composition of the constituents of the liquid sample. In some other embodiments is a solid material, e.g., a paint chip, taken from the damaged area 404.

FIG. 5 illustrates a picture 500 of a container 502 including an exemplary sample collected from a site, in accordance with one embodiment of the invention. The container 502 in some embodiments is, e.g., a vessel, tube etc., for holding a collected sample. In the picture 500, the container 502 is shown to be holding a sample 504 which may be, e.g., in a solid, liquid, semi-solid or gel form.

FIG. 6 illustrates a watermarked picture 600 which includes the picture 400 along with information 602. Thus picture 600 can be simply called a watermarked version of the picture 400 discussed above. The watermarked picture 600 is generated in some embodiments by the mobile communications device which has been used for taking the picture 400. FIG. 8 illustrates such an exemplary mobile communications device and will be discussed in detail later. In some embodiments the watermarking is performed by an application on the mobile communications device. In some embodiments the information 602 with which the picture 400 is watermarked is communicated from a sample processing facility such as the testing office 102. The information 602 includes a project and/or job identifier, an address corresponding to the site in the picture, date the picture was taken, and a sample identifier. It should be appreciated that the address used for watermarking the picture includes an office number, complex number, suite number and/or floor number in addition to the street address or the GPS location of the site. In various embodiments the watermarked picture 600 is printed and associated with the corresponding collected sample. In some embodiments associating the picture 600 includes securing said printed watermarked picture 600 to a container used to store the sample.

FIG. 7 illustrates a watermarked picture 700 which includes the picture 500 of the container 502 including the sample 504, along with information 702. Thus picture 700 can be simply called a watermarked version of the picture 500 discussed above. The watermarked picture 700 is generated in some embodiments by the mobile communications device which has been used for taking the picture 500. As discussed above, in some embodiments the watermarking is performed by an application on the mobile communications device. In some embodiments the information 702 with which the picture 500 is watermarked includes some information communicated from the sample processing facility such as the testing office 102 and additional information which is selected by, e.g., an operator handling the sample. For example, the information 702 includes same or similar information discussed with regard to item 602, in addition to that information 702 also includes container identifier which may have been selected by the operator handling the sample and taking watermarking the picture 500. In various embodiments the watermarked picture 700 is printed and associated with the container 502 including sample 504, to which the picture 700 corresponds.

FIG. 8 is a drawing of an exemplary mobile communications device 800, e.g., a handheld mobile device, in accordance with an exemplary embodiment. The mobile communications device 800 may be used as any one of the handheld devices 114, 118, 122 shown in the system of FIG. 1. In accordance with one aspect of the invention the mobile communications device 800 can be used to take sample pictures and/or to collect test data in real time from the field locations/sites, watermark the sample pictures with relevant information using an application on the mobile device 800 and communicate the watermarked pictures and other relevant test data/information to the web based test management server 104. The mobile communications device 800 can communicate information, e.g., wirelessly and/or using a physical connection, to other device and servers in the system. In some embodiments the mobile communications device 800 is one of a tablet device or a cell phone.

As shown in FIG. 8, exemplary mobile communications device 800 includes a receiver 802, a transmitter 804, user I/O devices 805, a processor 806, a camera 807, I/O interface 808 and memory 812 coupled together via a bus 810 over which the various elements may interchange data and information. The transmitter 804, e.g., a wireless transmitter, transmits information, e.g., collected test data, sample pictures, voice data, and/or other signals. Wireless transmitter 804 is coupled to transmit antenna 803 via which the mobile communications device 800 transmits the various signals to other devices. In some embodiments, the same antenna is used for the receiver and the transmitter.

Receiver 802 is responsible for receiving information from other devices. In some embodiments the receiver 802 includes a wireless receiver module and is coupled to a receive antenna 801 via which the mobile communications device 800 receives information from other devices. The received information 842 stored in the memory 812 is received via the receiver 802 from a sample processing facility such as the testing office 102. User I/O devices 805 include, e.g., microphone, keypad, keyboard, switches, speaker, display, etc. User I/O devices 805 allow a user of the mobile communications device 800 to input data/information, access output data/information and control at least some functions of the mobile device 800. The camera 807 is capable of capturing images and/or recording videos.

Memory 812 includes routines 814, various modules and data/information 840. The processor 806, e.g., a CPU, executes the routines 814 and one or more modules discussed below and uses the data/information 840 to control the operation of the mobile communications device 800 to implement one or more steps in accordance with the method of the present invention.

Routines 814 include a communications routine 816 and device control routines 818. The communications routine 816 implements the various communications protocols used by the mobile communications device 800. The device control routines 818 are used by the control module 820 to control the operation of various elements of the mobile communications device 800. Modules included in the memory 812 include an application module 822, e.g., a watermarking application, a communications module 824, and an encryption module 826. The application module 822 includes the watermarking application used by the mobile communications device 800 for watermarking one or more pictures, e.g., sample picture, site pictures etc., in accordance with the invention. When activated, the application module 822 controls the mobile device 800 to generate pictures watermarked with information corresponding to a project, job, site and/or sample on which testing is to be performed. FIGS. 6 and 7 illustrate examples of watermarked pictures which are generated by the mobile communications device 800 using watermarking application 822.

In some embodiments received information 842 received from the testing office 102 is used by the watermarking application module 822 for generating the watermarked pictures such as pictures 600 and 700. In some embodiments the watermarking application module 822 allows the user of mobile device 800 to enter additional information for watermarking a picture, e.g., using the keypad.

The communications module 824 is used for setting up communications with various other devices and systems. The communications module 824 uses the communications routines 816 which implement the various communications protocols supported by the mobile device 800 to set up communications with other devices and systems. The module 824 is configured to control the transmitter 804 and receiver 802 to transmit and receive information from other devices in accordance with the methods of the invention. For example the communications module 824 controls the transmitter 804 to wirelessly transmit one or more watermarked pictures to the testing office 102.

The encryption module 826 is used for encrypting watermarked pictures and/or test data corresponding to a collected test sample prior to transmitting the watermarked pictures and/or test data to the testing office 102.

Data/information 840 includes a plurality of stored sets of data/information including received information 842, digital pictures 844, and generated watermarked pictures 846. Received information 842 includes the information to be included in the pictures corresponding to one or more sites and/or samples to be tested and is received from the testing office 102 in some embodiments. As discussed above, the received information 842 includes at least one of job identification information, project identification information, site identification information, e.g., site address, sample identification information. Digital picture(s) include the digital pictures of one or more samples captured by the user using camera 807, such as pictures 400 and 500. The generated watermarked picture(s) 846 are generated by the watermarking application module 822 using the digital picture(s) 844 and the information 842 in accordance with the invention as discussed. Examples of generated watermarked pictures are illustrated in FIGS. 6 and 7.

In accordance with a feature of some embodiments, handheld applications which can be used in the handheld mobile communications device 800 are supported and provide users with industry specific applications to collect data from the field e.g., site. In some embodiments, application data is used to create legally defensible electronic Chain of Custody forms that are used in lieu of paper documents.

The users can download applications to a handheld device, including, but not limited to, phones, PDA's, notebooks, tablets, etc. to perform a variety of environmental services. In some embodiments the users enter data into intuitive forms and then electronically transfer information. Data is sent to the web management system, e.g., such as web management server 104, of the present invention where customized tables are presented and available for download, used to create reports or shared to persons or groups of persons, including but not limited to, business partners, laboratories, clients, etc. Some of the features of the applications which are included in the mobile communications device 800 in some embodiments include:

Create Customizable Forms in application

Create alarms and timers

Utilize automatic calculations for total area

Utilize automatic calculations for total volume

Electronic signature capture

Barcode capture

Tag sample data with specific location information at the site, e.g., room, floor number, text description (which may not be possible to automatically detect) of site and/or GPS location of the site

Create free form sketch

Ability to photograph and watermark photo with sample related information

Ability to record audio and link to job

Ability to record video and link to job

Synchronizes job data, pictures, videos, audio recordings with your web-based workspace

An exemplary method in accordance with the invention comprises: collecting a sample from a site; taking a picture of at least a portion of said site from which the sample was collected; and watermarking the picture with at least one of: site related information or project related information to generate a watermarked picture.

In some embodiments watermarking the picture includes incorporating a project or job identifier into the picture. In some embodiments watermarking the picture further includes incorporating an address corresponding to the site into the picture.

In some embodiments taking a picture further includes operating a digital camera to capture a digital image of said portion of the site. In some embodiments the digital camera is part of a mobile communications device, and the watermarking is performed by an application on said mobile communications device, e.g., such as the application 822 discussed above. In some embodiments the mobile communications device is one of a tablet device or a cell phone.

In some embodiments the exemplary method further includes wirelessly transmitting said watermarked picture to a sample processing facility. In some embodiments the exemplary method further includes encrypting the watermarked picture prior to transmitting said watermarked picture to said sample processing facility.

In some embodiments the exemplary method further includes receiving, at said mobile communications device, prior to said watermarking, information from said sample processing facility to be included in pictures corresponding to said site. In some embodiments the watermarking information includes at least one of job identification information or site identification information.

In some embodiments the exemplary method further includes printing the watermarked picture; and associating the printed watermarked picture with said sample. In some embodiments associating the printed watermarked picture with the collected sample includes securing said printed watermarked picture to a container used to store said sample.

In some embodiments the exemplary method further includes comprises storing said watermarked picture on a data storage device in association with test results corresponding to said sample; and making said watermarked picture and said test results electronically available to individuals associated with said test site.

Numerous features, embodiments and apparatus, as well as methods, are implemented in some but not necessarily all embodiments. These include but are not limited to the following:
1. A web-based management system providing an interface for customers to setup projects and assign geographical locations (buildings) to projects where data can be stored, tracked, used to create reports, shared, retrieved, and managed.
2. A handheld device adapted to collect data, e.g., test data, site and/or sample pictures or other data, from the field capable of providing users portable access to industry-specific programs, instructions and data. The customer can download existing applications or create forms to a handheld device, including but not limited to, phones, palm pilots, notebooks, etc. to collect data in real time from the field.
3. Field data synchronization and/or delivery are enabled in some embodiments using wireless capabilities resident in handheld personal computing devices. Data can be synchronized with a server over a network using wireless satellite transmission, or directly to a computer workstation using wireless infrared or radio transmission or connected physical connection. In some embodiments two-way communications is provided to facilitate real-time access to remote programs, assistance and/or information related to the field assessment being undertaken by using a handheld data management device user.
4. In situations where laboratory analysis is to be conducted, methods and systems are provided for maintaining a handwritten chain of custody record for the handling of an item transferred to a laboratory and/an electronic chain of custody or both. The electronic form is transferable among the users via the web-based management system. In one example, the data collector uploads data to interface and laboratory retrieves data authenticating the item. The information entered by the data collector is unalterable by the laboratory. After laboratory analysis, the lab uploads final results to a website.
5. Field data can be utilized to create project specific reports through report generation system. Report generator tool integrates predefined stencils with data to produce comprehensive reports.
6. A management system allows users to track progress of their projects by assigning milestones to that project. Once document is added to milestone, then this indicated.
7. The management system allows user to easily share project data with user or group of users. A sharer can assign certain privileges to sharee.
8. In various embodiments data can be managed and updated via the World Wide Web through either a computer or handheld device equipped with internet access. The report management system of the present invention is an innovative online document management system that provides an interface for you to setup projects where important environmental data can be input, organized, tracked, shared, managed, archived and retrieved.

The system delivers a powerful set of features that allow participants to take their projects to a whole new business level. By communicating in real time through a network, the report management system of the present invention allows true collaboration between you, your company as well as your business & lab partners. Every project, location, document, and user is securely stored and organized for easy, fast retrieval.

### Project Tracking

Reports, contracts, specifications, bid documents, laboratory data, licensing & credentials, project submittals, waste manifests—they're the lifeblood of Environmental projects and keeping track of them is difficult. With the report management system of the present invention, it's easy. With the online document management file, all this data can be stored in one place. Powerful, easy-to-use search functionality makes it easy to find and manage information without having to search through multiple files, folders, computers or networks. You create the milestones or placeholders for each document to be saved. Once files are finalized and uploaded, a status indicator is updated. Individuals who are entitled to can access documents and files from anywhere, and can see what percent complete the project is—all they need is a web browser.

Consistent standard to ensure regulatory and company policies

Reduce exposure to litigation & disputes

Resolve conflicts fast with a fully searchable audit trail

Increase employee productivity through time saving features & tracking

Easy enough for anyone to use

Network with Business Partners

The report management system of the present invention provides a professional network service for registered users to create a connection between themselves and their business partners. The purpose of this feature is to allow users to maintain a list of people they know and trust in business. The people in the list are called Business Partners. Users can invite anyone (whether an existing site user or not) to become a Business Partner.

This list of Business Partners can then be used in a number of ways:
A contact network is created by inviting a trusted contact (client, contractor, laboratory, subcontractor, etc.) to become your Business Partner or by having another registered user invite you to become their Business Partner. In either case, an email will be sent to the invited person requesting them to link. That user will have the option to accept or reject this offer.
Business Partners can then be used to share projects (consisting of multiple locations & documents), locations (consisting of multiple projects & documents) or documents only.
Registered users can also assign tasks and deadlines to their Business Partners via the Task Bulletin.

### Share Projects & Documents

Users can share any of your projects, locations and/or documents internally or with your Business Partners, Groups, or Users. Permissions allow you the ability to manage the rights and privileges of other users to view your information. For example, a User may want to share a project document (such as an Environmental Report) with another Business Partner, but may not want them to view other sensitive documents for that project.

An intuitive user interface makes it easy to quickly invite another to view project related documents for such reasons as bidding opportunities, compliance audits, etc. without compromising others to see unrelated confidential materials. When users invite another Business Partner to view their project an email notification is sent to that user announcing that a Project is available for them to view.

Share documents quickly and safely

Makes subcontracting work a snap

Save costs for printing, couriers and travel.

### Handheld Applications

Handheld applications are supported and provide registered users with industry-specific applications to collect environmental data from the field. Users download existing applications to a handheld device, including, but not limited to, phones, PDA's, notebooks, etc. to perform a variety of environmental services. Our system is a Windows-based program developed specifically for field data entry. It has been proven to increase worker productivity and consistency with over four years of field-testing. It is quick, efficient and user-friendly and increases data consistency and accuracy through industry standard dropdown and pick lists. Registered users are able to electronically transfer data files to the report management system of the present invention where customized tables are presented and available for download as excel reports.

Here's a rundown of some of the things that the system is well suited for:
Asbestos Bulk & Air Sampling
Lead-based paint XRF sampling
Lead in Dust, Soil & Air Sampling
View and edit sampling data on the report management system of the present invention
Create electronic Chain of Custody forms
Share data tables with your Business Partners

### Complete Laboratory Integration

The report management system of the present invention provides registered users a process to setup projects where environmental laboratory data can be collected, stored, tracked, shared, retrieved, and managed.

In situations where laboratory analysis is required, an electronic chain of custody form can be created utilizing our handheld application, which is then transferable to one of our authorized laboratories. The data collector just uploads the data to the report management system of the present invention, activates the file and the instantly the laboratory will receive it allowing them to log in the order before the samples arrive. The information entered by the data collector is unalterable by the laboratory. After laboratory analysis is completed, the lab will upload your results to the website and you can review them in a customized table provided by the report management system of the present invention.

Improve data consistency

Increase productivity

Ensure quality control & quality assurance

Built-in time saving features

### Affordable Safe & Secure Data Storage

Building a database management system is expensive and time consuming. With no up-front expenses, long-term commitments, staffing, or software the report management system of the present invention is the most cost-effective way to manage your environmental data. All it takes to sign up is a credit card. And all it takes to cancel is to close your account online. When we enjoy the economies of scale, we pass those savings onto you in the form of lower prices.

Customers are free to build their businesses and focus their energies and expenses on running their business and adding value to their customers. The report management system of the present invention makes it easy to ensure your data is quickly accessible, always available, and secure.

The report management system of the present invention delivers a number of benefits for our registered users, including one or more of the following:
Cost-effective—No pre-purchase commitments or minimum amount of use required.
Secure—Multiple layers of operational and physical security to ensure the integrity and safety of your data.
Transparent pricing—Our subscriptions are published for everyone to see and there are no hidden fees.
Economies of scale—We enjoy the economies of scale and pass those savings onto you.

The techniques of the present invention may be implemented using software, hardware and/or a combination of software and hardware. In the case of software, computer executable instructions used to control a processor may be stored in memory or another storage device and then executed by a processor. The present invention is directed to apparatus, e.g., devices such as telephones, servers, and/or other communications system elements which implement all or a portion of the present invention. It is also directed to methods, e.g., method of controlling and/or operating system elements to implement one or more portions of the methods of the invention. The present invention is also directed to machine readable medium, e.g., ROM, RAM, CDs, hard discs, etc., which include machine readable instructions for controlling a machine to implement one or more steps in accordance with the present invention.

In various embodiments devices described herein are implemented using one or more modules to perform the steps corresponding to one or more methods, for example, communicating information corresponding to a field location for testing to a management server, downloading test results to a client device from a server, etc. Thus, in some embodiments various features are implemented using modules. Such modules may be implemented using software, hardware or a combination of software and hardware. Many of the above described methods or method steps can be implemented using computer executable instructions, such as software, included in a computer readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a computer readable medium including computer executable instructions for causing a computer, e.g., processor and associated hardware, to perform one or more of the steps of the above-described method(s). Some embodiments are directed to a device, e.g., communications device, including a processor configured to implement one, multiple or all of the steps of one or more methods of the invention.

Some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a device or other apparatus described in the present application.

In some embodiments, the processor or processors, e.g., CPUs, of one or more devices, e.g., client device or the web based test and result management server, are configured to perform the steps of the methods described as being as being performed by the device or server. Accordingly, some but not all embodiments are directed to a device with a processor which includes a module corresponding to each of the steps of the various described methods performed by the device in which the processor is included. Each of the modules may be implemented using software and/or hardware.

Numerous additional variations on the methods and apparatus of the various embodiments described above will be apparent to those skilled in the art in view of the above description. Such variations are to be considered within the scope.

What is claimed is:

1. A sample collection method, the method comprising:
collecting a sample from a site;
taking a picture of at least a portion of said site from which the sample was collected; and
watermarking the picture with at least one of: site related information or project related information to generate a watermarked picture.

2. The method of claim 1, wherein watermarking the picture includes:
incorporating a project or job identifier into the picture.

3. The method of claim 2, wherein watermarking the picture further includes:
incorporating an address corresponding to the site into the picture.

4. The method of claim 3, wherein taking a picture includes:
operating a digital camera to capture a digital image of said portion of the site.

5. The method of claim 4,
wherein said digital camera is part of a mobile communications device; and
wherein said watermarking is performed by an application on said mobile communications device.

6. The method of claim 5, wherein said mobile communications device is one of a tablet device or a cell phone.

7. The method of claim 7, further comprising:
wirelessly transmitting said watermarked picture to a sample processing facility.

8. The method of claim 7, further comprising:
encrypting said watermarked picture prior to transmitting said watermarked picture to said sample processing facility.

9. The method of claim 8, further comprising:
receiving, at said mobile communications device, prior to said watermarking, information from said sample processing facility to be included in pictures corresponding to said site.

10. The method of claim 9, wherein said information includes at least one of job identification information or site identification information.

11. The method of claim 10, further comprising:
printing said watermarked picture; and
associating said printed watermarked picture with said sample.

12. The method of claim 11, wherein associating said printed watermarked picture with the collected sample includes securing said printed watermarked picture to a container used to store said sample.

13. The method of claim 9, further comprising:
storing said watermarked picture on a data storage device in association with test results corresponding to said sample; and
making said watermarked picture and said test results electronically available to individuals associated with said test site.

14. An apparatus, comprising:
a camera for taking a picture of at least a portion of a site from which a sample was collected; and
a watermarking module for watermarking the picture with at least one of: site related information or project related information to generate a watermarked picture.

15. The apparatus of claim 14, wherein said watermarking module is configured to:
incorporate a project or job identifier into the picture.

16. The apparatus of claim 15, wherein said watermarking module is further configured to:
incorporate an address corresponding to the site into the picture.
